(19) United States
(12) Patent Application Publication
(10) Pub. No.: US 2006/0127581 A1
(43) Pub. Date: Jun. 15, 2006

(54) Method for on-demand direct item marking via a screen printing process

(76) Inventor: Glenn David Aspens, Cincinnati, OH (US)

Correspondence Address: ORUM & ROTH, 53 W. JACKSON BLVD, CHICAGO, IL, 60604, US

(21) Appl. No.: 11/009,726

(22) Filed: Dec. 10, 2004

Related U.S. Application Data
(60) Provisional application No. 60/528,785, filed on Dec. 11, 2003.

(51) Int. Cl. B05D 1/32

(52) U.S. Cl. 427/282

(57) ABSTRACT

A method of on-demand direct item marking is provided. The customer creates the format of the desired image and prints, via thermal transfer printing, the image in negative image to create the stencil. The base material of the stencil is a thin, porous material. The openings on the mesh allow the flow of inks or other fluids while the printed areas prevent the flow of the marking material. The stencil is applied to the product. Marking fluid such as ink is wiped across the stencil using any known method, for example a squeegee method. The ink travels through the open sites or pores of the stencil and not the printed or closed sites. The stencil is then removed, leaving a positive image on the target surface.

This application claims the benefit of U.S. Provisional Application 60/528,785 filed 11 Dec. 2004.

### BACKGROUND OF THE INVENTION

1. Field of the Invention

The present invention relates to a method and apparatus for on-demand marking of objects via a screen-printing method directly on the object. More specifically, the invention relates to on-demand stencils created by depositing a coating material on a porous substrate using a printer. The coated areas of the stencil are used to selectively block a marking fluid applied to the various surfaces.

2. Description of Related Art

Many industries have a sound business case for automatic ID, but are currently unable to mark their products due to service environments that are inhospitable to current marking technologies. Silk screening data directly onto products eliminates failure points with labels (printed image, film, and adhesive durability all must endure environmental conditions), but currently has a cumbersome process for generating stencils.

Prior art screen-printing methods required use of cumbersome, time-intensive processes for generating stencils. This process was typically a photographic, UV cured method for stencil generation. This method had multiple drawbacks:
a. The process is time intensive, making it impractical for real-time item marking.
b. The process involves multiple steps between determining the image and creating the stencil.
c. The process involves large, fixed equipment, making marking in multiple locations impractical. In addition, moving the stencil generating station to the point of use is difficult or impossible, creating a data lag when used.

Prior art on-demand stencils for electro-chemical etching can only be used to mark certain bare metal surfaces. There is a need for a screen-printing process that allows target surfaces such as painted metal, plastic, glass, and wood to be marked with text, machine-readable symbols, and graphics.

Some objects that would otherwise be capable of being marked using the prior art process are subjected to conditions such as high temperatures, solvent exposure, and abrasive exposure that render the prior art method unsuitable as a method of marking. There is a need for an on-demand screen printing process that can be used on objects that are subjected to high temperatures, solvents, and abrasives or other conditions that are incompatible with prior art processes.

It is an object of the present invention to solve these and other problems that will become apparent to one skilled in the art reviewing the following figures, description and claims.

### SUMMARY OF THE INVENTION

The inventive on-demand stencil printing process provides a method for selectively regulating the porosity of a porous base material via deposition of a thermal transfer ink layer, thus generating a screen printing (such as silk screen printing) stencil on-demand.

On-demand stencils for electro-chemical etching are limited in scope; only certain bare metal surfaces can be marked with this method. Using the inventive screen-printing process, new target surfaces such as painted metal, plastic, glass, wood, and others can be marked with text, machine-readable symbols, and graphics. The use of an on-demand stencil frees the user to mark the items with dynamic, real-time data. Durable direct part marking is currently limited to some bare metals; other target surfaces, high temperatures, solvent exposure, and abrasion render some customers' products incompatible with current processes.

The base material of the inventive stencil is a thin, porous material. The openings on the mesh allow the flow of inks or other fluids. The porous material (i.e. a mesh) is provided on a low-peel adhesive carrier for transport through the thermal printer and cutter; the carrier can easily be removed before use. In order to create a stencil, the openings in the mesh are selectively covered and closed by transferring a layer of ink from a thermal transfer ribbon. The inked areas on the carrier prevent the flow of ink for marking through the printed areas of the mesh. By printing the ink in a negative image, a screen is created that allows the ink to flow through the stencil in the open sites and generate a positive image.

The customer creates the format of the desired image, and prints via thermal transfer, the image in negative image. The stencil will is then applied to the product. Ink or marking fluid is then wiped, using any known method, for example a squeegee method, across the stencil. The ink travels through the open sites of the stencil, and not the printed or closed sites. The stencil is then removed, leaving a positive image on the target surface.

### BRIEF DESCRIPTION OF THE FIGURES

FIG. 1 is a representation of one embodiment of the present invention.

FIG. 2 is a side view of an on-demand stencil showing the various layers thereof.

FIG. 3 is a top view of an on-demand stencil demonstrating use of a print zone free of adhesive and an easy peel-off liner having a narrower width than the stencil material.

FIG. 4 is a diagram of an on-demand stencil system.

### DETAILED DESCRIPTION

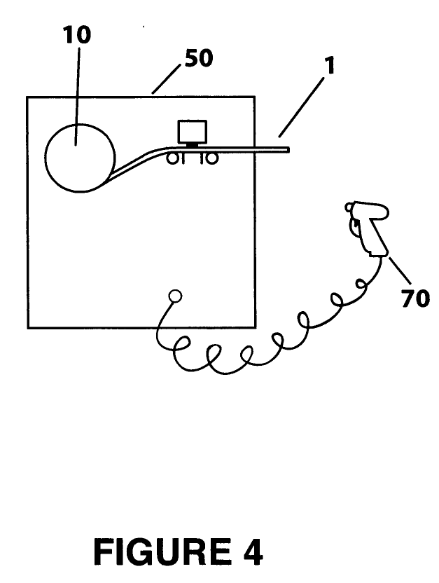

As shown in FIG. 4, a woven or cloth-like fabric, mesh or spunbound porous medium 10 (stencil material) is supplied to a printer 50. The stencil material 10 preferably has a mesh count in the range of about 150-600 threads per inch and/or a maximum pore or interstice diameter of 0.003 inch. The selection of mesh density and/or porosity is dependent upon the resolution desired. A high thread count and small pore diameter enables increased resolution by supporting smaller individual negative areas of the desired image. The porous material (i.e. a mesh) is provided on a low-peel adhesive carrier for transport through the thermal printer and cutter; the carrier can easily be removed before use. In order to create a stencil, the openings in the mesh are selectively covered and closed by transferring a layer of ink from a printer, preferably thermal transfer ribbon.

The printer 50 may be any form of imaging device, for example, thermal, inkjet, bubblejet, laser or hotmelt inkjet with a thermal transfer printer being preferred. The printer 50 deposits a coating material 5, for example, ink, resin, wax, composite or polymer on the desired negative areas of the stencil material 10. Preferably, the coating material is thermal transfer ink. To provide a uniform surface across all areas not intended to create a mark an increased coat weight of, for example, up to 3.5 times normal is used, thereby sealing the pores and forming a uniform sealing surface. If the stencil material 10 is engineered with a high surface energy, the filling of the pores in the stencil material 10 may be performed at less than 100% sealing. The high surface energy would not allow the marking solution or ink to wet out and flow into any small openings left uncovered.

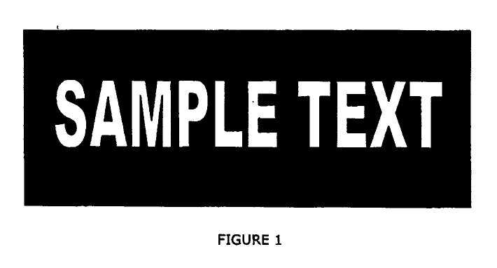

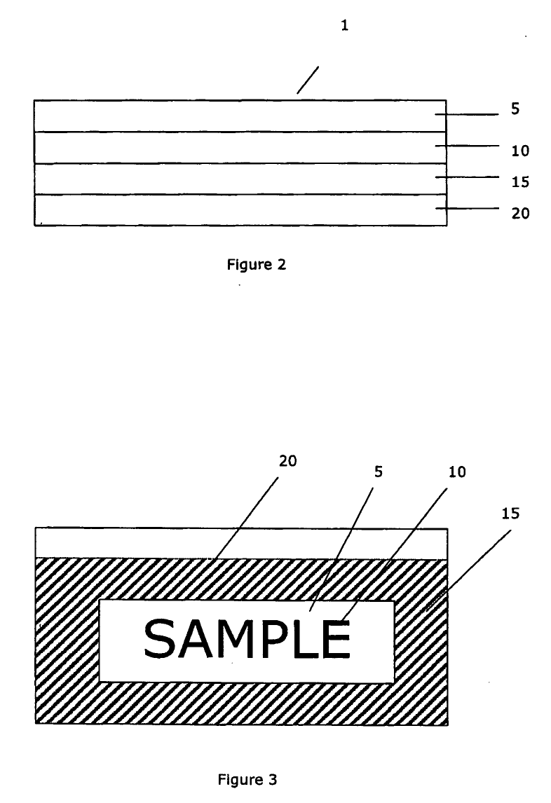

The stencil material 10 surface is porous, permitting mass transport through it, allowing the marking solution to pass through the media that has not been negative printed upon, as shown in FIG. 1, to contact the surface of the object. The coating material 5 may be provided in a color contrasting the stencil material 10 to provide contrast and easy viewing of the finished stencil without requiring holding the stencil up to the light.

In a second embodiment, the stencil material 10 may be provided with an adhesive 15, used to adhere a liner 20 and or adhere the finished stencil 1 to an object to be marked. The adhesive may be applied on the back side of the stencil or along the backside edges only. The adhesive 15 may have full release and or low residue properties. As shown in FIG. 3, care must be taken to ensure that any adhesive used does not block the stencil material 10 pores in the area desired for image transfer. One method is to define a print area upon which no adhesive 15 is applied.

In any embodiment, a liner 20 may be provided to support the stencil material 10 as it passes through the printer 50 and/or the cutter. A liner may also be used to cover the adhesive 15 prior to stencil application. A liner 20 that is larger or smaller than the stencil material 10 aids in initiating the peel off of the liner from the stencil material. If desired, the stencil material 10 may be provided in a linerless embodiment, ready for immediate application.

The marking solution is preferably a fluid ink appropriate for the target surface and the durability requirements of the environment of the target surface. It can be water- or solvent-based, UV cured, or another formulation. The ink is preferably tailored to the surface to be marked and the environmental conditions that it must endure while the item is in service. The ink can be a color that contrasts with the surface for easy visibility. It can match the surface or be formulated with non-visible taggants for covert marking. The marking solution can be formulated to be visible or invisible to the human eye. The marking solution can be any known type of ink. For example, it can be infrared ink, ultraviolet ink, reflective ink, or magnetic ink.

In use, the on-demand stencil is formatted with the desired symbols, and the indicia data sent to a printer to be negative printed. The printer filling all areas of the porous medium not desired to become part of the resulting mark with a coating material. Use of reverse printing for the indicia created, for example, utilizing industry standard software such as BARTENDER or third generation Intermec Programming Language (IPL3) permits the finished stencil to be placed coated side down, creating a better seal against the surface.

The surface to be marked is preferably cleaned to remove any dirt, chemical or oil residue. If the stencil is supplied with a liner, the liner is removed and adhesive for adhering the stencil to the surface, if present, exposed. The stencil is then adhered or otherwise affixed to the surface to be marked.

The marking fluid is then applied to the stencil, allowing the fluid to penetrate the stencil in the open sites; the coated sections of the stencil block fluid movement. In this manner, the positive image is generated on the surface.

After the fluid has been applied, the stencil is peeled from the surface. Leaving a section of the stencil periphery free of adhesive aids in the stencil removal, allowing the user to easily grasp a corner of the stencil to initiate removal by peeling it off.

If a machine readable symbology has been incorporated into the stencil, the stencil and/or the finished mark may be verified by scanning the symbology and comparing it to the desired symbology. Where an on demand stencil has been created immediately prior to application, the comparison may be done while the electronic data used to format/print the stencil is still locally available, for example by using a direct or network interconnected scanner 70 and printer 50. Thereby enabling immediate verification of high volume/density data prior to stencil application and or of the finished marked metal that would be difficult or tedious for a human operator to manually compare and or verify.

In an alternative embodiment, the image is printed in positive image.

The present invention is entitled to a range of equivalents and is to be limited only by the following claims.

I claim:

1. A method for on-demand direct item marking comprising the steps of:
supplying a porous stencil media to a printer,
forming of a reverse print image on the media by depositing a coating material on the media to form a coated area and an uncoated area,
substantially sealing the pores of the media in the coated area,
affixing the stencil to a surface of an object to be marked such that a coated side of the media faces the surface of the object,
applying a marking solution to the object,
passing the marking solution through the pores in the uncoated area to create a finished mark, and
removing the stencil from the object after the marking solution has been applied.

2. The method of claim 1 further comprising the steps of:
defining a stencil region,
applying adhesive to the coated side of the stencil, and
leaving the stencil region free from adhesive,
wherein the stencil is affixed to the object by the adhesive.

3. The method of claim 2 further comprising the steps of:
applying a liner to cover the adhesive
removing the liner and exposing the adhesive before the stencil is affixed to the object.

4. The method of claim 1 further comprising the steps of:
cleaning the surface to be marked before affixing the stencil.

5. The method of claim 1 further comprising the step of preventing the marking solution from passing through the pores in the coated area.

6. The method of claim 1 further comprising the step of verifying the finished mark.

7. The method of claim 6 further comprising the step of scanning the finished mark.

8. The method of claim 6 further comprising the step of visually comparing the finished mark with a desired mark.

9. The method of claim 1 further comprising the step of selecting a mesh density and/or porosity and selecting a media that meets those criteria.

10. The method of claim 9 wherein the thread count of the media is between about 150-600 threads per inch.

11. The method of claim 9 wherein the maximum pore interstice distance is about 0.003 inch.

12. The method of claim 1 further comprising the step of selecting the marking solution based in the target surface, durability requirements and/or object environment.

13. The method of claim 1 wherein the coating materials is deposited by a printer and the printer is selected from the group consisting of thermal transfer printer, inkjet printer, bubble jet printer, laser printer, and hot-melt inkjet printer.

14. The method of claim 13 wherein the printer is a thermal transfer printer.

15. The method of claim 1 wherein the coating material is selected from the group consisting of ink, resin, composite, and polymer.

16. The method of claim 14 wherein the coating material is thermal transfer ink.

17. The method of claim 1 wherein the porous media is selected from the group comprising woven fabric, cloth-like fabric, mesh, and spun bound porous media.

18. The method of claim 1 wherein the porous media has a high surface energy.

19. The method of claim 18 wherein the ink coating is less than 100% sealing

20. The method of claim 1 wherein the coating material is deposited as a uniform layer.

21. The method of claim 1 wherein the ink coating has a greater coat weight than normal.

22. The method of claim 1 wherein the ink coating is up to 3.5 times the normal coat weight.

23. The method of claim 1 wherein the stencil media and the coating material are of different colors.

24. The method of claim wherein the marking solution is selected from the group consisting of fluid ink, water-based ink, solvent-based ink, UV-curable ink and combinations thereof.

25. The method off claim 24 wherein the ink is a different color than the surface of the object.

26. The method of claim 24 wherein the ink matches the surface of the object.

27. The method of claim 24 where the ink is clear or invisible when applied to the object.

28. The method of claim 24 wherein the ink is formulated with non-visible taggants.

29. The method of claim 1 wherein the mark is selected from the group consisting of symbols, machine readable symbology, logos, text and combinations thereof.

30. The method of claim 2 wherein at least one peripheral region of the stencil free of adhesive.

31. A method for on-demand direct item marking comprising the steps of:
selecting a mesh density and/or porosity and selecting a porous stencil media that meets those criteria,
supplying the porous stencil media to a printer,
forming of a reverse print image on the media by depositing a coating material on the media to form a coated area and an uncoated area,
substantially sealing the pores of the media in the coated area,
applying adhesive to the coated side of the stencil and leaving a stencil region free from adhesive,
cleaning the surface to be marked before affixing the stencil,
affixing the stencil to a surface of an object to be marked such that a coated side of the media faces the surface of the object,
selecting a marking solution based in the target surface, durability requirements and/or object environment,
applying the marking solution to the object,
passing the marking solution through the pores in the uncoated area to create a finished mark, and
removing the stencil from the object after the marking solution has been applied
verifying the finished mark.
